(19) United States
(12) Patent Application Publication
(10) Pub. No.: US 2025/0343337 A1
(43) Pub. Date: Nov. 6, 2025

(54) LEAD ASSEMBLY PIN GUIDE

(71) Applicant: CPS Technology Holdings LLC, New York, NY (US)

(72) Inventors: Mark D. GUNDERSON, Bristol, WI (US); Ronald J. DULLE, Mequon, WI (US); Rengaraj BALAKRISHNAN, Raleigh, NC (US)

(21) Appl. No.: 19/143,704

(22) PCT Filed: Dec. 29, 2023
(86) PCT No.: PCT/US2023/086525

§ 371 Date: Jun. 26, 2025

Related U.S. Application Data
(60) Provisional application No. 63/477,658, filed on Dec. 29, 2022.

(51) Int. Cl. H01M 50/569; H01M 10/42; H01M 10/48; H01M 50/284; H01M 50/503; H01M 50/552; H01M 50/553

(52) U.S. Cl. CPC H01M 50/569; H01M 10/4257; H01M 10/486; H01M 50/284; H01M 50/503; H01M 50/553; H01M 50/561

(57) ABSTRACT

A system for determining a battery cell parameter of one or more battery cells of a battery is described. The system includes a BMS which includes a plurality of electrical connection points and a lead guide with a plurality of openings. Each opening is arranged to receive and guide a corresponding BMS connector to a corresponding electrical connection point on the BMS. Each opening has a first portion with a first end and a second portion with a second end. The first end has a first diameter. A diameter of the first portion has a tapered diameter from the first end of the first portion to the second portion. The BMS also includes processing circuitry electrically coupled to one or more electrical connection points and configured to determine the battery cell parameter of the battery cell(s) at least via the corresponding electrical connection point.

### TECHNICAL FIELD

This disclosure relates to batteries and in particular to a smart battery to facilitate battery performance/failure monitoring.

### BACKGROUND

As battery technology evolves, the demand for improved power sources such as energy storage modules for vehicles continues to grow. Existing battery systems, for example lead acid battery systems, typically offer limited access to performance and failure monitoring. More specifically, existing lead acid battery systems may not be capable of providing one or more battery parameters (e.g., usable to determine performance and/or predict/monitor failure) of one or more battery cells of the lead acid battery system. In other words, it is difficult for existing lead acid battery systems to provide information about vital components, such as the state of health of the battery cells. Accordingly, the state of health of battery cells cannot be monitored and/or determined, thus hindering the ability to predict upcoming battery failure or the onset of failure.

It may be possible to monitor various battery parameters by placing various components of the battery and a battery monitoring system in contact either electrically or mechanically with one other. However, this placement of the various components of the battery and the battery monitoring system in close proximity and/or in contact with one another can be difficult and challenging. Also, the various parts of the battery and the battery management system may be damaged if in close proximity and/or in contact with one another. This type of damage can render a particular portion of the battery and/or the battery management system inoperable. Additionally, any damage to a part or component of the battery and/or the battery management system can render the entire system inoperable.

### SUMMARY

Some embodiments advantageously provide a method and apparatus, e.g., smart battery. In some embodiments the apparatus includes element(s) connecting at least one lead to a corresponding battery cell. The lead(s) may be connected to a battery management system (BMS), e.g., to determine/measure at least one parameter, such as cell temperature, voltage, current, temperature, etc. In some embodiments, one lead is connected to a terminal of the battery and another lead is connected to one battery cell. In some other embodiments, more than one lead is connected to battery cells. In a nonlimiting example, the battery includes six leads, where each one of five leads is connected to one battery cell, and the sixth lead is connected to a positive terminal of the battery. However, the battery is not limited as such and may include any quantity of leads and/or each lead be connected to one or more components of the battery, e.g., battery cells. In some other embodiments, connecting leads to battery cells includes connecting each lead to one post that is connected to one battery cell.

In one or more embodiments, battery cell temperature sensing is described. e.g., for multiple battery sizes. In some other embodiments, a printed circuit board (PCB) mount temperature sensor (i.e., circuit element) is described, e.g., flexible circuit or wired interface may not be required. In some embodiments, a thermal pad providing thermal conductor and electrical insulator to cast-on strap (COS) for battery cell temperature is described. Multiple thermal sensors and locations may be used for different group sizes (e.g., battery group sizes, thermal pads, battery component sizes, etc.). In some embodiments, the thermal pad may have a predetermined dimension (e.g., length, width, height).

Further, in some other embodiments, a cell voltage sense concept is described. More specifically, a lead guide is described. The lead guide may comprise openings having tapered barrels. The opening may comprise through hole tapered barrels which may be inserted in the board (e.g., PCB) of the BMS to provide a guide and connection point to a lead assembly (e.g., lead frame) to facilitate assembly of the battery.

In some embodiments, a snap-fit lead guide may be used such as to support a BMS connector (e.g., pin) insertion. In some other embodiments, a connector for parameter sensing such as voltage sensing (Vsense) is described.

According to one aspect, a system for determining a battery cell parameter of one or more battery cells of a battery is described. The battery includes a plurality of posts and a plurality of leads. Each post is couplable to one battery cell, and each lead has a first end and a second end opposite to the first end. The first end is a battery management system (BMS) connector. The second end is coupled to one post. The system includes a BMS which includes a plurality of electrical connection points and a lead guide with a plurality of openings. Each opening is arranged to receive and guide a corresponding BMS connector to a corresponding electrical connection point on the BMS. Each opening has a first portion with a first end and a second portion with a second end. The first end has a first diameter. A diameter of the first portion has a tapered diameter from the first end of the first portion to the second portion. The second portion has a second diameter that is smaller than the diameter of the first end and the tapered diameter from the first end of the first portion to the second portion. The BMS also includes processing circuitry electrically coupled to one or more electrical connection points of the plurality of electrical connection points and configured to determine the battery cell parameter of the one or more battery cells at least via the corresponding electrical connection point.

In some embodiments, the lead guide further includes at least one guide formed as part of a corresponding opening.

In some other embodiments, each opening from the plurality of openings has a round shape.

In some embodiments, the lead guide has two guides.

In some other embodiments, the each guide is disposed on the first end of the first portion.

In some embodiments, the second end of the second portion has a third diameter, the third diameter being the same as the second diameter.

In some other embodiments, the battery further includes a bushing couplable to the battery cell and coupled to the post.

In some embodiments, at least one electrical connection point is couplable to the bushing and the BMS, the BMS being configured to determine a voltage of the battery cell using the at least one electrical connection point.

In some other embodiments, at least the first diameter of the first end of the first portion of the opening is adjustable.

In some embodiments, the BMS further includes a circuit board, the lead guide is positioned in a predetermined region on the circuit board such that the BMS connector can be aligned with at least one opening from the plurality of openings of the lead guide.

In some other embodiments, one or more electrical connection points is aligned with a corresponding opening.

In some embodiments, one or more electrical connection points comprise a conductor layer electrically coupled to the processing circuitry and arranged to receive and electrically couple to the BMS connector.

In some other embodiments, the lead guide comprises a portion corresponding to at least one opening that is electrically coupled to the processing circuitry and arranged to electrically couple to the BMS connector to the processing circuitry.

According to another aspect, a method for coupling a plurality of battery management system (BMS) connectors to a lead guide in a battery is described. The battery includes a plurality of posts and a plurality of leads. Each post is couplable to one battery cell, and each lead has a first end and a second end opposite to the first end. The first end is the BMS connector, and the second end is coupled to one post. The battery includes a BMS. The BMS includes the lead guide and a plurality of connection points. The lead guide has a plurality of openings. The method includes placing the lead guide over the plurality of BMS connectors. Each opening is arranged to receive and guide a corresponding BMS connector to a corresponding electrical connection point on the BMS. Each opening has a first portion with a first end and a second portion with a second end. The first end has a first diameter and the diameter of the first portion has a tapered diameter from the first end of the first portion to the second portion. The second portion has a second diameter that is smaller than the diameter of the first end and the tapered diameter from the first end of the first portion to the second portion. The method also includes performing a first alignment of at least a portion of the BMS with the plurality of leads. In addition, the method also includes after the first alignment is performed, pushing the BMS toward the plurality of leads. The pushing causes each opening of the plurality of openings to receive and guide the corresponding BMS connector of the plurality of BMS connectors to the corresponding electrical connection point on the BMS. Further, the method includes electrically coupling each electrical connection point with the respective BMS connector to determine a voltage of the one or more battery cells at least via the corresponding electrical connection point.

In some embodiments, the BMS further comprises a processing circuitry, each electrical connection point includes a conductor layer electrically coupled to processing circuitry. The method further includes electrically coupling the conductor layer to the respective BMS connector.

In some other embodiments, the method further includes performing a second alignment of the respective BMS connector with the conductor layer.

In some embodiments, the BMS further includes a processing circuitry. The lead guide includes a portion corresponding to at least one opening that is electrically coupled to the processing circuitry. The method further includes electrically coupling the respective BMS connector to the processing circuitry via the portion corresponding to the at least one opening.

In some other embodiments, the BMS further includes a processing circuitry and a connector coupled to the processing circuitry. The method further includes electrically coupling the respective BMS connector to the processing circuitry via the connector.

In some embodiments, the connector is individually connected to each connection point of the plurality of connection points.

In some other embodiments, each opening from the plurality of openings further includes at least one guide, and the method further includes inserting one BMS connector into one opening proximate the at least one guide.

### BRIEF DESCRIPTION OF THE DRAWINGS

A more complete understanding of embodiments described herein, and the attendant advantages and features thereof, will be more readily understood by reference to the following detailed description when considered in conjunction with the accompanying 15 drawings wherein:

FIG. 1 shows an example battery and one or more components of the example battery according to the principles of the present disclosure;

FIG. 2 shows an example battery (e.g., exploded view) and one or more components of the example battery according to the principles of the present disclosure;

FIG. 3 shows example leads according to the principles of the present disclosure;

FIG. 4 shows an example lead assembly according to the principles of the present disclosure;

FIG. 5 shows an example lead assembly connected to corresponding couplings according to the principles of the present disclosure;

FIG. 6 shows an example battery management system (BMS) coupled to a lead assembly according to the principles of the present disclosure;

FIG. 7 shows a view of an example board of the BMS according to the principles of the present disclosure;

FIG. 8 shows another view of the example board of the BMS which is opposite the view in FIG. 7 according to the principles of the present disclosure;

FIG. 9A shows a view of the lead guide according to the principles of the present disclosure;

FIG. 9B shows a cross-sectional view of one opening of the lead guide of FIG. 9A according to the principles of the present disclosure;

FIG. 9C shows another cross-sectional view of one opening of the lead guide of FIG. 9A according to the principles of the present disclosure;

FIG. 9D shows another cross-sectional view of one opening of the lead guide of FIG. 9A according to the principles of the present disclosure;

FIG. 10 shows another cross-sectional view of one opening of the lead guide of FIG. 9A with at least one member according to the principles of the present disclosure;

FIG. 11 shows an example BMS according to the principles of the present disclosure;

FIG. 12 shows steps of coupling a pad to one or more components of a battery according to the principles of the present disclosure;

FIG. 13 shows a view of an example pad coupled to one or more components of a battery according to the principles of the present disclosure;

FIG. 14 shows an example process of aligning a connector within a lead guide according to the principles of the present disclosure; and

FIG. 15 shows another example process of aligning a connector within a lead guide according to the principles of the present disclosure.

### DESCRIPTION

As battery technology evolves, there is a need to provide improved power sources, and more efficient and effective methods for manufacturing such power sources as compared to conventional systems and methods.

Accordingly, embodiments described and shown herein provide a battery and method of assembly of the battery that allows smart features to be integrated within a battery that, in some embodiments, can take the same general shape and form as batteries that do not offer “smart” battery features, such as (as a non-limiting example) the ability to monitor individual cell voltages. In some embodiments, at least one lead to a corresponding battery cell may be connected to a battery management system (BMS), e.g., to determine/measure at least one parameter, such as cell voltage, cell current, cell temperature, etc. In some embodiments, lead guides are used for connecting leads to a BMS. In some other embodiments, a thermal pad (e.g., comprising a circuit element) may be used.

In some embodiments, the term couple (or connect) may refer to physically and/or electrically coupling (e.g., connecting) one or more components. For example, coupling a first component to a second component comprises physically coupling and/or electrically coupling the first component to the second component. In some embodiments, coupling may comprise thermally coupling, i.e., establishing contact (direct/indirect) between a first and a second component. For example, a first component may be coupled to the second component where thermal energy is transferred or conducted from the first element to the second element and/or vice versa. In some other embodiments, coupling may further comprise coupling (e.g., physically coupling and/or electrically coupling) one or both of the first and second components to a third component.

In some embodiments, the term thermistor is used and may refer to an electrical circuit element which may be a type of resistor having a resistance that is dependent on temperature. For example, when using a thermistor, a variation in temperature corresponding to the thermistor causes a variation in resistance of the thermistor, e.g., resistance is directly proportional to the temperature.

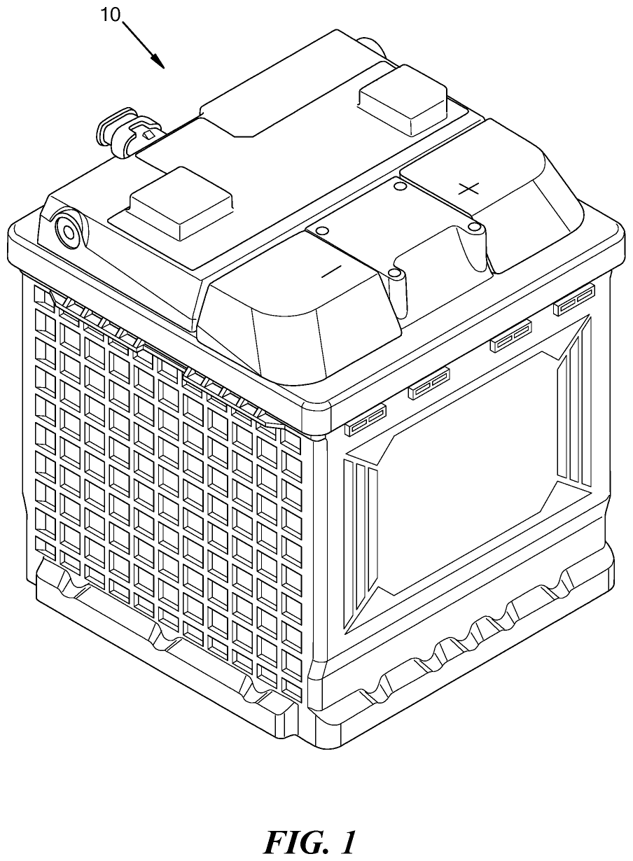

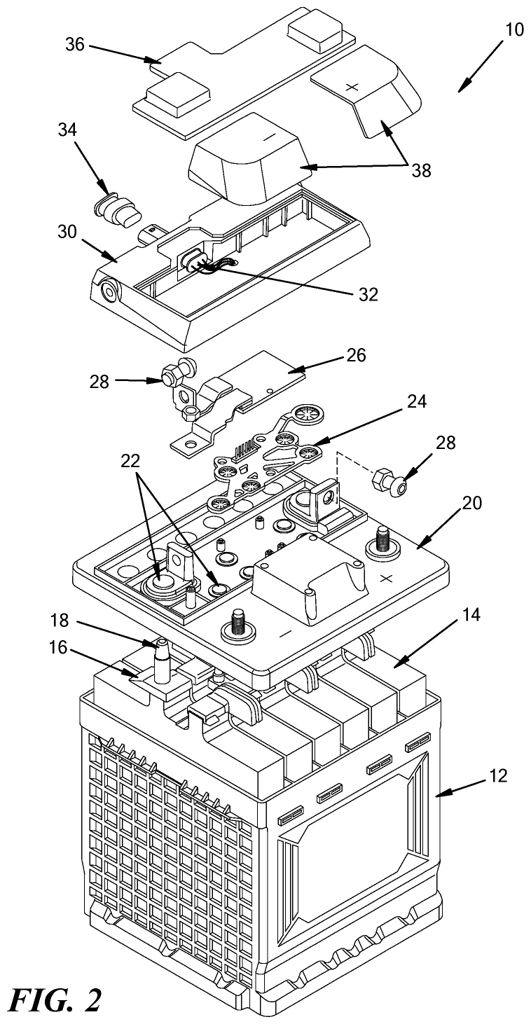

FIGS. 1 and 2 show an example battery (e.g., a lead acid battery having a smart Absorbent Glass Mat (AGM) battery assembly) and one or more components of the example battery. Battery 10 may include at least one of the following: a case 12 (which may be made of from a resin or any other suitable material), one or more battery cells 14, a post assembly 16 (e.g., Cast-On-Strap (COS) post assembly), one or more posts 18 (e.g., a terminal post, a mini-post), a first cover 20, one or more bushings 22 (e.g., a Ul bushing, a mini-bushing), a lead assembly 24 (e.g., a lead frame), a battery management system 26 (e.g., including a board), one or more fasteners 28, a second cover 30, a wiring harness 32, a vehicle connector 34, a third cover 36, and one or more terminal caps 38.

In some embodiments, battery 10 may include a multi-compartment system: battery cells compartment and a BMS compartment (space comprising BMS 26). The case 12, the first, second, and third covers 20, 30, 36 (and/or any other battery components) may be made of any polymeric (e.g., polyethylene, polypropylene, a polypropylene containing material, etc.) or composite (e.g., glass-reinforced polymer) material. For example, case 12 may be made of polypropylene-containing material (e.g., pure polypropylene, co-polymers comprising polypropylene, polypropylene with additives, etc.). Such polymeric material is resistant to degradation caused by acid (e.g., sulfuric acid) provided within cells of the case.

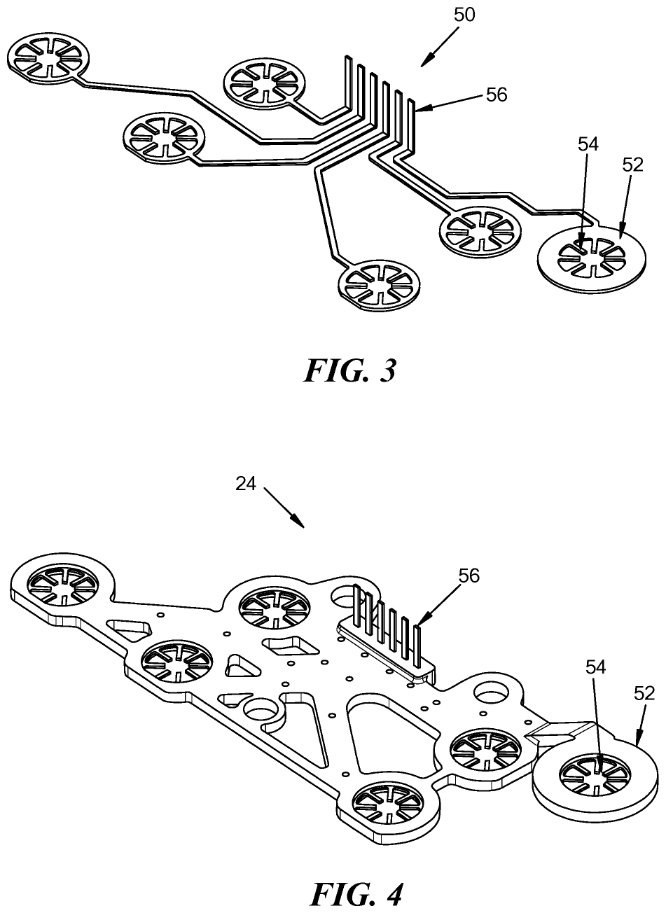

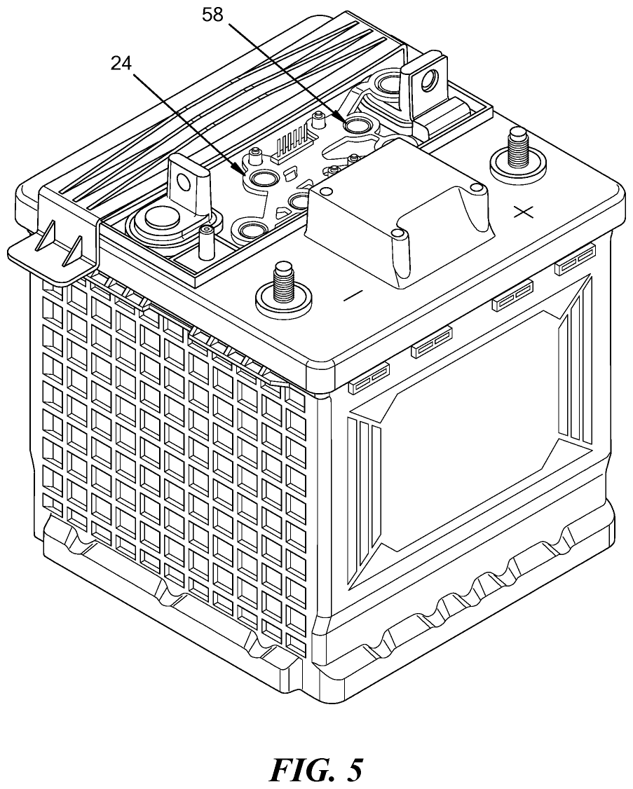

FIG. 3 shows an example of a plurality of leads 50 (e.g., six leads). FIG. 4 shows a lead assembly 24 (e.g., including the plurality of leads 50). Each lead 50 may include one or more of each of the following: a lead ring 52, a post connector 54 (e.g., a spoke) comprised in one end each lead 50, and a lead BMS connector 56 (e.g., pin, board connector, spade, etc.) comprised in another end of each lead 50. Ring 52 and/or post connector 54 may be arranged to physically and/or electrically connect lead 50 to post 18 and bushing 22 (e.g., by being coupled (e.g., by welding it) to post 18 and/or bushing 22, and/or forming weld 58. BMS connector 56 may be arranged to extend from the ring and/or bend to a predetermined angle and/or physically and/or electrically connect to BMS 26 (and/or any of its components). Lead 50 may be made of any material including conductive materials, e.g., to conduct electricity and/or propagate signals. In a nonlimiting example, lead 50 may refer to a stamped frame and/or be made of at least one of copper, brass, steel, aluminum, titanium, platinum, etc. Further, lead 50 may include a coating and/or a finish such as a finish using copper, nickel, tin, palladium, silver, gold, zinc, etc. Lead 50 may be used by BMS 26 to measure/determine one or more parameters associated with a battery cell 14. Parameters may include, without limitation, voltage, current, temperature, pressure, etc., and may be associated with any component of battery 10, e.g., post 18, battery cell 14, etc. Lead(s) 50 (e.g., stamped leads) may be comprised in a lead assembly 24, e.g., an over molded assembly) as shown in FIG. 4. The lead assembly 24 may comprise lead frame 25. In some embodiments, the lead frame 25 is the coating and/or finish. Further, lead assembly 24 may comprise one or more openings 60 arranged for coupling lead assembly 24 to first cover 20.

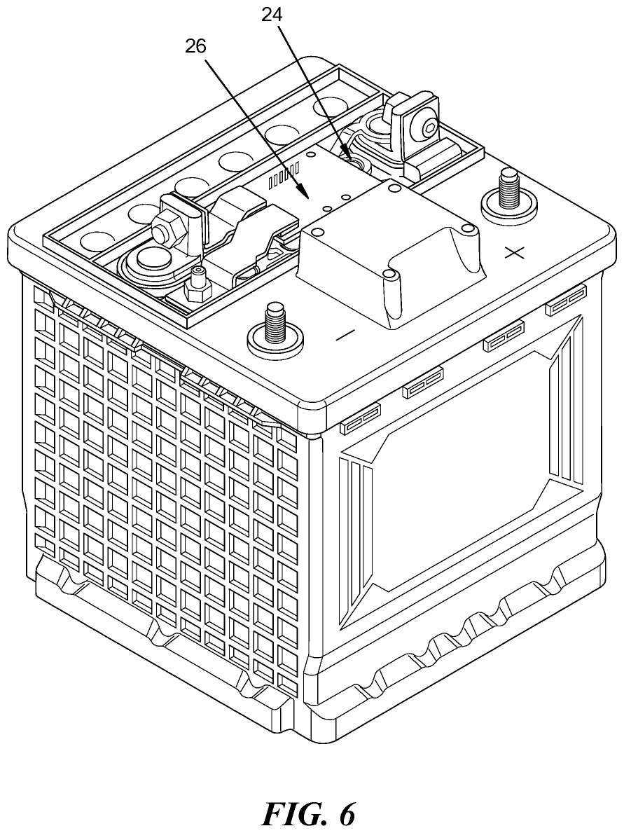

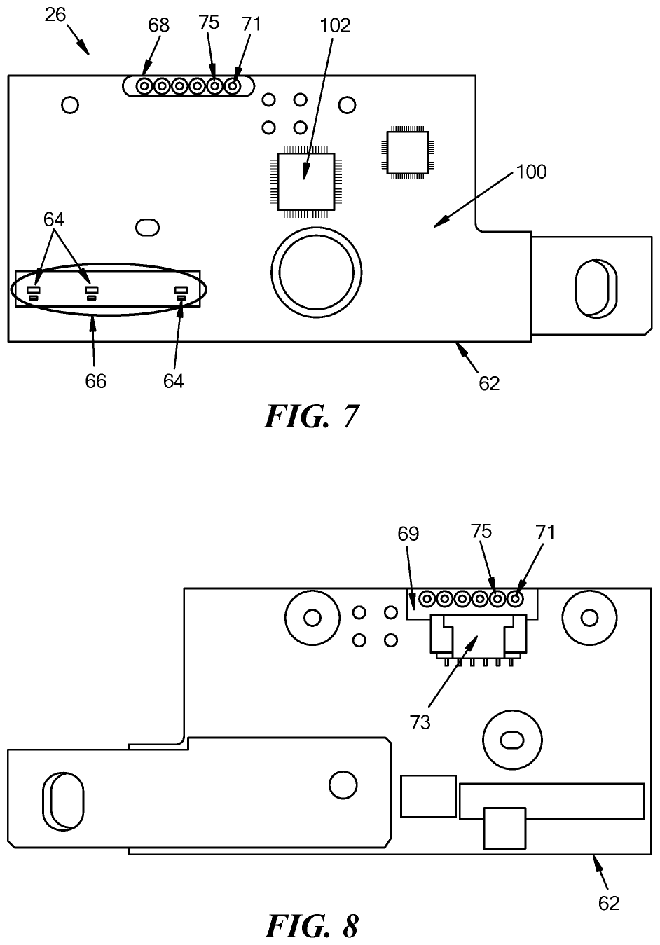

FIG. 5 shows an example lead assembly 24. Lead assembly 24 is coupled (e.g., physically and/or electrically coupled) to a weld 58 (e.g., a weld of bushing 22 and post 18). In other words, each one of the leads 50 of lead assembly 24 is coupled to a corresponding post 18 and/or bushing 22 and/or battery cell 14. FIG. 6 shows an example BMS 26 coupled to a lead assembly 24. In this nonlimiting example, BMS 26 is electrically connected to one or more battery cells 14 at least via leads 50 of lead assembly 24.

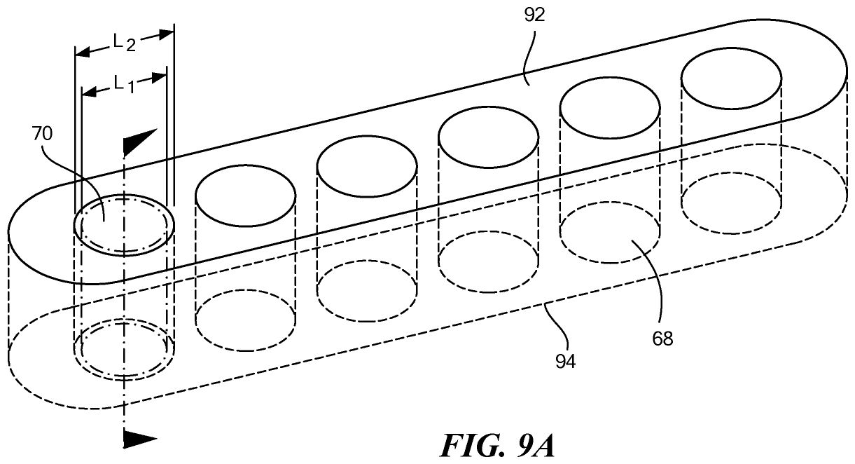

FIG. 7 shows a view of an example board 62 of a BMS 26 according to the principles of the present disclosure. BMS 26 may comprise board 62, one or more sensors 64, processing circuitry 100, processor 102, etc. Sensors 64 may be positioned within a region 66 on the bottom of circuit board 62 that is separated from the other elements of BMS 26, e.g. to allow for thermal isolation such that the heating of the other elements of BMS 26 does not impact the reading of sensor 64 and the heating of sensor 64 does not impact the other elements. In some embodiments, further temperature isolation of region 66 is accomplished by affixing other elements of BMS 26 to the opposite, i.e., top, side of circuit board 62 while region 66 is located on the bottom side of circuit board 62. Providing multiple temperature sensors 64 within region 66 of BMS circuit board 62 allows a single BMS 26 to be used in batteries of different physical sizes, e.g., different battery groups, while ensuring that the corresponding pad 112 will still come into physical contact with a sensor 64 when the BMS 26 is installed during battery assembly. Although FIG. 7 shows three temperature sensors 64, it is understood that fewer than three or more than three temperature sensors 64 can be used depending on the particular design requirements.

Further, BMS 26 may comprise a lead guide 68. Lead guide 68 may comprise one or more openings 70 and/or apertures, which may in a non-limiting example include the shape of tapered barrels and/or tapered through hole barrels. For example, the tapering may include the narrowing or reduction in length and/or diameter within opening 70. The one or more openings 70 may be sized and shaped to receive leads 50 (and/or BMS connectors of the leads) and couple the leads to BMS 26. The shape of the one or more openings 70 serve at least to guide the leads 50 of lead assembly 24 through the corresponding openings in circuit board 62 during installation of the BMS 26 as part of the assembly of the battery, thereby providing an arrangement under which the leads 50 do not have to be perfectly aligned with their corresponding openings in the BMS circuit board 62 during battery assembly. This arrangement facilitates and speeds up assembly of the battery and reduces the likelihood of a bend or unconnected lead 50.

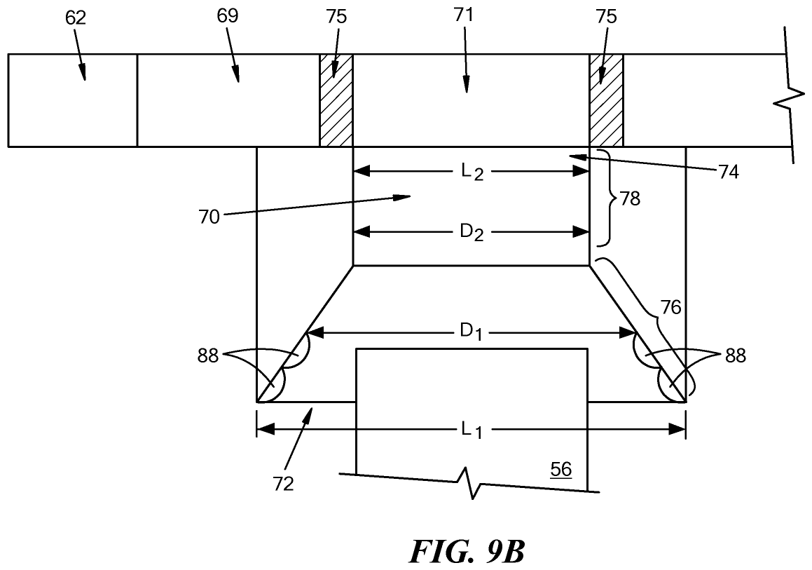

FIG. 8 shows another view of the example board 62 of the BMS 26 according to the principles of the present disclosure. More specifically, the view of FIG. 8 is opposite to the view of FIG. 7 and may show elements similar to those of the BMS 26 shown in FIG. 6. BMS 26 of FIG. 8 comprises a connection point section 69 and one or more electrical connection points 71 (each of which may include a conductor layer 75). Any one of connection point section 69 and one or more electrical connection points 71 may be formed when BMS board 62 is fabricated. At least one electrical connection point 71 is aligned with a corresponding opening 70 (shown in FIG. 7). For example, at least one electrical connection point 71 may define an opening and be arranged to receive (in the opening) and physically and/or electrically couple to a BMS connector 56 of lead 50, thereby establishing an electrical connection between the BMS connector 56 of lead 50 and processing circuitry 100 of the BMS 26 (and/or any other component of BMS 26). Further, BMS 26 may also include a connector 73 (e.g., Vsense connector or voltage sense connector), which may couple to one or more electrical connection points 71. That is, the electrical connection between BMS connector(s) 56 and the processing circuitry 100 (and/or any other component of BMS 26) may be performed at least via the corresponding electrical connection points 71 and connector 71. Further, connector 71 may comprise one or more conductors electrically coupled to processing circuitry 100, where at least one conductor is coupled to a corresponding electrical connection point 71 and/or corresponding BMS connector 56.

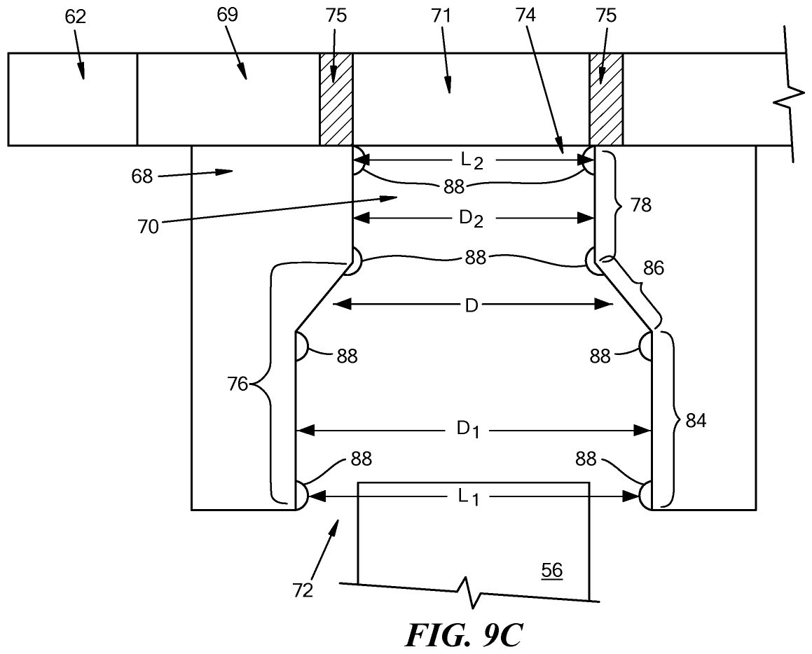

FIG. 9A is an example of the lead guide 68 with a plurality of openings 70 which is part of the BMS 26. As a non-limiting example, the lead guide 68 may have six openings that penetrate through the lead guide 68 from a top portion 92 of the lead guide 68 through to the bottom portion 94 of the lead guide 68. The top portion 92 may be coupled to a bottom surface of BMS 26, such as to align openings 70 with a corresponding electrical connection point 71. Further, each opening 70 may extend through the lead guide 68 from the top portion 92 through to the bottom portion 94 so that a BMS connector 56 that is inserted into opening 70 can be inserted through the entire lead guide 68 from the bottom portion 94 through to the top portion 92 and extend outwardly from the top portion 92 of the lead guide 68 and into an electrical connection point 71. Of course, it is understood that the lead guide 68 can have more or fewer than six openings 70. In some embodiments, the lead guide 68 is made of an electrically insulating material, e.g., a polymer such that the function of lead guide 68 is strictly mechanical in nature. In other embodiments, the lead guide 68 can be fabricated such that the surface of the openings 70 is at least partially coated with an electrically conductive material to facilitate the transmission of electrical signals from the BMS connectors 56 to the

FIG. 9B is an example of a cross-sectional view of one opening 70 in the lead guide 68 and circuit board 62 which are part of the BMS 26. Circuit board 62 of BMS 26 is coupled to lead guide 68 and comprises connection point section 69 and at least one electrical connection point 71. Electrical connection point 71 may define an opening that is aligned with opening 70. Further, electrical connection point 71 may comprise conductor layer 75 which may be distributed around the periphery of the opening defined by electrical connection point 71 and arranged to electrically couple to BMS connector 56. Connection point section 69 and conductor layer 75 may be a contiguous electrical conductor and formed together when circuit board 62 is fabricated. Conductor layer 75 may also be plated together connection point section 69 (and/or with other components of BMS 26). In addition, electrical connection point 71 and/or conductor layer 75 may be aligned with opening 70. However, electrical connection point 71 and/or conductor layer 75 are not limited as such, e.g., electrical connection point 71 and/or conductor layer 75 may be shifted from the position shown in FIG. 9B or define an opening that is larger or smaller than that shown in FIG. 9B. In some embodiments, the lead guide 68 is made of an electrically insulating material, e.g., a polymer such that the function of lead guide 68 is strictly mechanical in nature. In other embodiments, the lead guide 68 can be fabricated such that the surface of the openings 70 is at least partially coated with an electrically conductive material and in electric communication with the corresponding electrical connection point 71 to facilitate the transmission of electrical signals from the BMS connectors 56 to their corresponding electrical connection points 71.

In this view of the opening 70, the cross-sectional view of the opening 70 within the lead guide 68 is shown with the shape and general dimensions of the opening 70 which may not be visible from the view (shown in FIG. 8). BMS connector 56 is shown as being inserted into a part of opening 70. It will be understood that the lead guide 68 may have one opening 70 or a plurality of openings 70. Each of the openings 70 may be sized and shaped to correspond with or to receive at least one BMS connector 56 and guide the BMS connector 56 to electrical connection point 71. For example, while only one opening 70 is shown, there may be in one exemplary embodiment six different openings 70 that can accommodate each BMS connector 56 that is part of the plurality of leads 50. Alternatively, depending upon the placement and design of each BMS connector 56 on the leads 50, more than one BMS connector 56 may be inserted into one opening 70. Also, each opening 70 may have the same general size and shape or each opening 70 may have a different size and shape as well to accommodate BMS connector 56. Each individual BMS connector 56 can be inserted into the respective opening 70 and the BMS connector 56 can be maneuvered through opening 70 and electrical connection point 71. Also, when each BMS connector 56 is inserted into opening 70, the placement of each BMS connector 56 in the opening 70 is important so that each BMS connector 56 is in electrical communication with the BMS 26 via electrical connection point 71 and/or conductor layer 75. It is essential to have proper placement of each BMS connector 56 in the opening 70 so that each BMS connector 56 is aligned within opening 70 and/or the opening defined by via electrical connection point 71 and/or conductor layer 75 to allow for electrical communication with the BMS 26 (and/or its components).

Each opening 70 (and/or the corresponding portion of the lead guide 68) may have at least a portion with a generally tapered shape or any other shape arranged to facilitate inserting and/or securing BMS connector 56 to opening 70. In one exemplary embodiment, the opening 70 has a first end 72 which may be where the BMS connector 56 is initially inserted into the lead guide 68. For example, the first end 72 may be the end shown in FIG. 8 in the lead guide 68. Proximate the first end 72, lead guide 68 may include at least one guide 88 (e.g., a lip) within the opening 70 which may be on one or both sides of the first end 72. Guide 88 may be arranged to further assist with the insertion of BMS connector 56 into the opening 70. For example, guide 88 may have a semicircular shape so that when BMS connector 56 is inserted into opening 70, guide 88 will move the BMS connector 56 toward and into the opening 70, e.g., without causing damage to BMS connector 56. The opening 70 may also have a second end 74 that is opposite the first end 72. The second end 74 may be the end that is shown in FIG. 7 in the lead guide 68. As shown in FIG. 9B, the opening size Lj on the first end 72 may be larger than the opening size L₂ of the second end 74. The larger opening size L₁ at the first end 72 may allow the lead guide 68 to be more easily inserted into the opening 70 as the size of the opening 70 on the first end 72 may be larger than the size of the opening 70 at the second end 74. When the opening size is smaller, insertion of the BMS connector 56 may be difficult. It will also be understood that opening 70 may be a variety of different shapes and sizes. As discussed generally with respect to FIG. 9A, the opening 70 may generally have a circular shape that varies in size and/or diameter within opening 70. However, it will be understood that the opening 70 does not require a circular shape and may be a square, irregularly shaped, as well as any other shape that is sized and shaped to accommodate the BMS connector 56.

The opening 70 may have a first portion 76 and a second portion 78 of the opening 70 where the first portion 76 is contiguous with the second portion 78. The first portion 76 of the opening 70 may be sized and shaped to have a diameter and/or length of the opening that is largest at the first end 72 and tapers in size toward the second end 74. For example, the first portion 76 of the opening 70 may have a diameter L₁ at the first end 72, and the diameter of first portion 76 may taper in size from first end 72 of the first portion 76 toward the second portion 78 as shown in D₁. The first portion 76 may include the first end 72 with the largest diameter of the opening 70 and the diameter of the first portion 76 may continually taper in size from the first end 72 toward the second portion 78 such that the diameter consistently changes and gets smaller within the first portion 76. The large opening at the first end 72 allows for the BMS connector 56 to be more easily inserted into the opening 70, and the tapering of the first portion 76 from the first end 72 toward the second portion 78 allows the BMS connector 56 to be guided through the first portion 76 of the opening 70 toward the second portion 78. In some embodiments, the second portion 78 of the opening 70 may have a smaller diameter D₂ than the first portion 76. In some other embodiments, the second portion 78 may be in electrical communication with other components of BMS 26 such as a BMS board 62, a BMS processor, etc., where the second portion 78 comprises another conductor layer in electrical communication with the BMS processor or processing circuitry or any other component of BMS 26. The smaller diameter of the second portion 78 may be sized and shaped so that when the BMS connector 56 is contained within the second portion 78 of the opening 70. The diameter D₂ of opening 70 may be the same diameter throughout the second portion 78. As shown in this figure, the diameter of the second portion 78 is the same from where the first portion 76 and the second portion 76 connect with one another up to the second end 74 of the opening 70.

The lead guide 68 may also optionally include at least one lever, and the at least one lever may be configured to increase or decrease the size of the opening 70. The lever may be a movable bar that is attached at a fixed point and is movable in an upward and downward motion. However, it will be understood that the at least one lever may be a push button or another configuration to allow a user to increase and/or decrease the size of opening 70. The size of opening 70 may be increased and/or decreased at the top portion 92 and/or the bottom portion 94 of the lead guide 68. For example, the length L₁ of the first end 72 of opening 70 may increase or decrease in size based upon the movement of at least one lever. The lever may have connections (e.g., mechanical linkage, mechanical connections, etc.) where lever is mechanically connected to at least one opening 70. The lever may be moved in a first direction to increase the size of the opening 70 and the lever may be moved in a second direction to decrease the size of the opening 70. As a non-limiting example, lever maybe moved in an upward direction to decrease the size of the opening 70 or in a downward direction to increase the size of the opening 70. The lead guide 68 may have one lever that can control all the openings or a plurality of levers to control the openings. There may be one lever associated with each opening 70 so that the user can individually control the size of each opening 70 or alternatively one lever can control all openings 70 on the lead guide 68. In addition, lever may be used to secure BMS connector 56 to opening 70 as well.

As one example, the lead guide 68 (e.g., lead guide assembly) may be coupled with board 62 and board 62 may be coupled with first cover 20. When lead guide 68 is coupled with board 62, it is often necessary for the BMS connectors 56 to be aligned within connection points 71. The size and shape of each of the openings 70 may help align the BMS connectors 56 within each opening 70 to guide the BMS connectors 56 to the connection points 71 so that there is electrical connectivity between the BMS connector 56 and the leads 50 with other components of BMS 26 such as a BMS board 62, a BMS processor, etc. The BMS connector 56 may be inserted into first end 72 of opening 70. Once the BMS connector 56 is inserted into opening 70 and pushed further into opening 70 toward second end 74, the size and shape as well as various components within the opening 70 can align the BMS connector 56 within the opening as BMS connector 56 moves from first end 72 toward second end 74. The lever 80 can adjust the size of opening 70 so that BMS connector 56 can be moved into alignment when inserted into opening 70. The guides 88 may also move BMS connector 56 into alignment after insertion into opening 70 by moving BMS connector 56 away from the edges of opening 70 and toward the center of opening 70. The BMS connector 56 may be continually pushed through opening 70 so that BMS connector 56 comes into contact with second portion 78 of opening 70 and the corresponding connection point 71.

In some embodiments, as BMS connector 56 moves through opening 70 from first end 72 toward second end 74, the lever may be moved from a first position to where the opening 70 is unobstructed and at the maximum diameter to a second position where opening 70 is decreased in size so that BMS connector 56 may be aligned within opening 70. The lever may be moved to a variety of different positions to adjust how the size of opening 70. For example, lever may be moved and adjusted incrementally into a variety of different positions so the diameter of opening 70 can also be adjusted incrementally as well. This allows significant control over where the BMS connector 56 is located and aligned within opening 70. In some other embodiments, when the BMS connector 56 comes into contact with second portion 78 of opening 70, the BMS connector 56 may be electrically connected with second portion 78 of opening 70.

Now referring to FIG. 9C which shows another exemplary embodiment of opening 70. Circuit board 62 of BMS 26 is coupled to lead guide 68 and comprises connection point section 69 and at least one electrical connection point 71. Electrical connection point 71 may define an opening. The opening and/or electrical connection point 71 may be aligned with opening 70 and/or one or more guides 88. Further, electrical connection point 71 may comprise conductor layer 75 which may be distributed around the periphery of the opening defined by electrical connection point 71 and arranged to electrically couple to BMS connector 56. Conductor layer 75 may be aligned with opening 70 and/or one or more guides 88. In the embodiment as shown, the first end 72 may have a length L₁ which is uniform in a first section 84 of the first portion 76. The length of L₁ is the longest length of opening 70 to allow for the easy insertion of BMS connector 56 into the opening 70. The shape and sizing of the opening 70 helps to guide BMS connector 56 from the first end 72 toward the second end 74 and electrical connection point 71. The first portion 76 may also have a second section 86 which is contiguous with the first section 84 and may be the same size and shape as the first section 84 or may be a different size and shape as the first section 84. In this exemplary embodiment, second section 86 is smaller than first section 84. For example, second section 86 of the first portion 76 may have a diameter D which is tapering from a larger diameter to a smaller diameter from where the first section 84 and the second section 86 meet and moving toward the second portion 78. The diameter D of the second section 86 of the first portion 76 may be smaller than the diameter of first portion 76 but where the first section 84 and the second section 86 converge, the diameter D of the second section 86 may be the same as the diameter D₁ of the first section 84.

At least the shape of the first section 84 allows the BMS connector 56 to be easily inserted into the large opening, and then the tapering of diameter D₁ in second section 86 assists in guiding the BMS connector 56 into the second portion 78 which has a smaller diameter D₂ than the tapered diameter of second section 86. Having this type of size and shape allows the BMS connector 56 to move through opening 70 from the first end 72 toward the second end 74 without being damaged. This size and shape with the smaller diameter D₂ of the second portion 78 allows the BMS connector 56 to be contained in the second portion 78 of opening 70 while BMS connector 56 may be in electrical communication with the BMS board 62, a BMS processor, etc. via electrical connection point 71 In the second portion 78, the diameter D₂ may be uniform and not change throughout the second portion 78 such that the diameter D₂ of the second portion 78 is the same as the diameter of the second end 74. However, it will be understood that the diameter of the second portion 78 may taper in size from the first end 72 toward the second end 74 in the second portion 78. In this embodiment, guide 88 may also be found inside of the opening 70. For example, if there are edges within opening 70, guide 88 may be placed in various locations within opening 70 to help further facilitate a smooth transition of the BMS connector 56 as it is moved through opening 70 from first end 72 toward second end 74. As shown in this exemplary embodiment, there may be guides 88 at the transition from the first section 84 to the second section 86 of the first portion 76 and there may be guides 88 on the transition from the first portion 76 toward the second portion 78. Finally, in this exemplary embodiment, guides 88 may also be disposed at the second end 74 so that the BMS connector 56 does not come into contact with the edges which are found at second end 74 of opening 70.

Now referring to FIG. 9D is another exemplary embodiment of opening 70. Circuit board 62 of BMS 26 is coupled to lead guide 68 and comprises connection point section 69 and at least one electrical connection point 71. Electrical connection point 71 may define an opening. The opening and/or electrical connection point 71 may be aligned with opening 70 and/or one or more guides 88. Further, electrical connection point 71 may comprise conductor layer 75 which may be distributed around the periphery of the opening defined by electrical connection point 71 and arranged to electrically couple to BMS connector 56. Conductor layer 75 may be aligned with opening 70 and/or one or more guides 88. As shown in this embodiment, opening 70 may have a continually tapered design from the first end 72 to the second end 74 to allow BMS connector 56 to be inserted into the first end 72 and be guided toward the second end 74 of opening 70 and electrical connection point 71. First end 72 of first portion 76 has the largest diameter at L₁ where the BMS connector 56 may initially be inserted into opening 70. In this embodiment, first portion 76 is contiguous with the second portion 78 and does not have an abrupt change in the diameter within the first portion 76 and the second portion 78. Rather, in this embodiment the diameter in opening 70 gradually becomes smaller from the first end 72 to the second end 74. This allows for the BMS connector 56 to be inserted into the first end 72 and then be guided through to the second end 74 of the lead guide 68 and electrical connection point 71 without damaging the BMS connector 56 when it is inserted into the opening 70. Further, first end 72 may include at least one guide 88 so that any edges at first end 72 are smooth and easily transition the BMS connector 56 through the first end 72 and into the first portion 76 of the first opening. While guides 88 are only shown in this exemplary embodiment at the first end 72, it will be understood that guides 88 may be placed throughout opening 70 to facilitate a smooth transition of BMS connector 56 through opening 70.

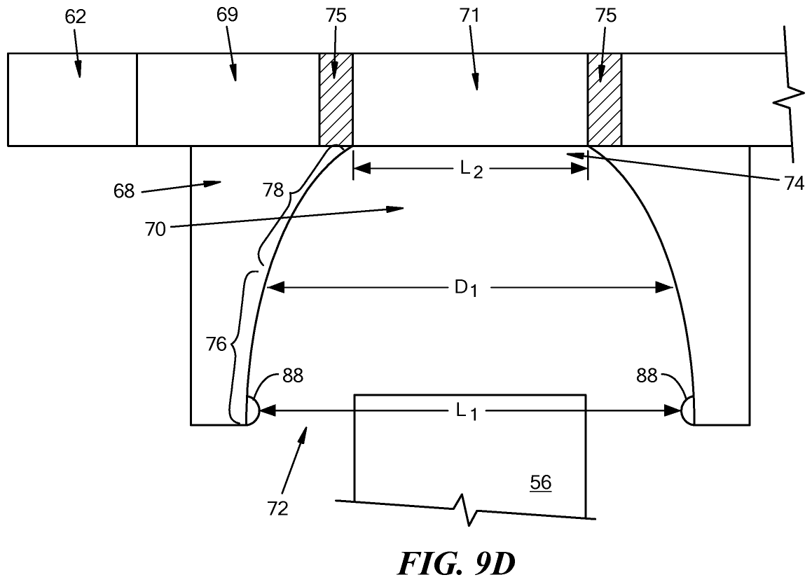

Now referring to FIG. 10, another cross-sectional view of one opening 70 of the lead guide 68 of FIG. 9A with at least one member 90 is shown. Circuit board 62 of BMS 26 is coupled to lead guide 68 and comprises connection point section 69 and at least one electrical connection point 71. Electrical connection point 71 may define an opening. The opening and/or electrical connection point 71 may be aligned with opening 70 and/or one or more guides 88. Further, electrical connection point 71 may comprise conductor layer 75 which may be distributed around the periphery of the opening defined by electrical connection point 71 and arranged to electrically couple to BMS connector 56. Conductor layer 75 may be aligned with opening 70 and/or one or more guides 88. In this embodiment, the BMS connector 56 is inserted into opening 70 and is guided through opening 70 based upon the size and shape of opening 70 along with the assistance of various members 90 which provide further assistance in aligning the guiding BMS connector through opening 70 from the first end 72 toward the second end 74. Each member 90 may protrude outwardly into the opening 70 to help guide BMS connector 56 through the opening so that BMS connector 56 does not come into contact with the sides of opening 70. Opening 70 may have one or more than one member 90 within opening 70. In one exemplary embodiment, opening 70 may further include at least one sensor 96 (e.g., location and/or proximity sensor), and the sensor 96 may be configured to detect the position and placement of the BMS connector 56 as it moves through opening 70.

As shown in FIG. 10, sensor 96 may protrude from the wall of opening 70. However, it will be understood that sensor 96 may be flush with the wall of opening 70 so as not to obstruct any portion of opening 70 or sensor 96 may have a rounded shape so if BMS connector 56 comes into contact with any sensor 96 within opening 70, the BMS connector 56 will not be damaged. Each sensor 96 may be in communication with at least one member 90 (and/or processing circuitry 100) and depending upon the location of the BMS connector 56 within opening 70 as detected by sensor 96, this detection may trigger certain members 90 to be extended into opening 70 to guide the movement of BMS connector 56 while other members 90 may also be retracted within the lead guide 68. Each member 90 may be extendable into opening 70 at various lengths and may be retracted completely within lead guide 68. The member 90 may be comprised of various components 91 so that member 90 may be collapsed to the size of each component 91 when each component 91 is retracted into the lead guide 68. For example, if BMS connector 56 has been inserted into the first end 72 of opening 70 and it is moving toward to left side of opening 70, members 90 on the left side of opening 70 may be extended into opening 70 to guide BMS connector 56 toward the center of opening 70 and/or electrical connection point 71. Alternatively, if BMS connector 56 is inserted into the first end 72 of opening 70 and it is moving toward the right side of opening 70, members on the right side of opening 70 may be extended into opening 70 to guide BMS connector 56 toward the center of opening 70. The members 90 may also be activated independently by a user as BMS connector 56 is inserted into opening 70 to guide BMS connector 56 from first end 72 to second end 74 of opening 70.

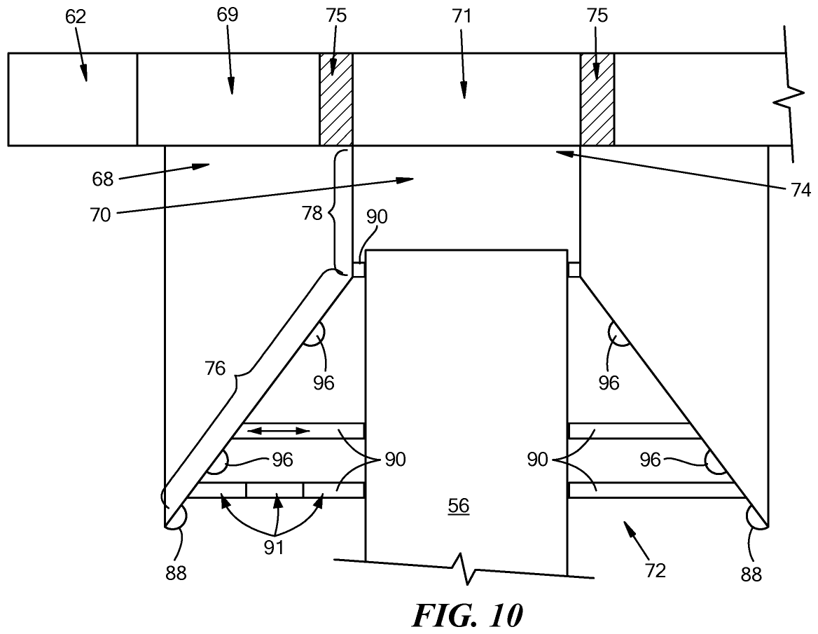

FIG. 11 shows an example BMS 26. BMS 26 may include at least one of processing circuitry 100, processor 102, memory 106, battery state unit 108, and connector interface 110. In some embodiments, BMS 26 also includes pad 112 and/or sensor 64 and/or member 90 and/or sensor 96 which may be configured to perform one or more actions and communicate with any of the other components of BMS 26. Processing circuitry 100, which may have storage and/or processing capabilities. The processing circuitry 100 may include processor 102 and memory 106. In particular, in addition to or instead of a processor, such as a central processing unit, and memory, the processing circuitry 100 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 102 may be configured to access (e.g., write to and/or read from) memory 106, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 100 may be configured to control any of the methods and/or processes described herein and/or to cause such methods, and/or processes to be performed, e.g., by BMS 26 and/or battery 10 which includes but is not limited to the members 90 and sensor 96. Processor 102 corresponds to one or more processors 102 for performing battery 10 functions described herein. Memory 106 may be configured to store data, programmatic software code and/or other information described herein. In some embodiments, software may include instructions that, when executed by the processor 102 and/or processing circuitry 100, causes the processor 102 and/or processing circuitry 100 to perform the processes described herein. The instructions may be software associated with BMS 26 and/or battery 10. Further, battery state unit 108 may be configured to perform any of the steps and/or methods and/or functions and/or processes and/or features of the present disclosure, e.g., by BMS 26 and/or battery 10. Connector interface 110 may be any interface arranged/configured to connect to (and/or communicate with) any other device and/or component of battery 10 such as any lead 50 and/or vehicle connector 34 and/or wiring harness 32 and/or any device by wireless/wired communication, e.g., using any communication protocol. Connector interface 110 may be in communication with any of the components of battery 10, such as pad 112, sensor 64, member 90, sensor 96, processing circuitry 100, processor 102, memory 106, and/or battery state unit 108. Further, any of the components of BMS 26 may be in physical/electrical communication with lead guide 68, opening 70, lever 80, members 90, and/or sensors 96 (and/or their respective portions, components, etc.). In one nonlimiting example, processing circuitry 100 and/or processor 102 and/or memory 106 and/or battery state unit 108 and/or connector interface 110 may be in electrical communication (via one or more conductors) with opening 70 (and/or a corresponding BMS connector 56 of a lead 50). Lead ring 52 and/or post connector 54 of lead 50 may be coupled to post 18 (which is coupled to a battery cell 14), thereby establishing an electrical connection from BMS 26 (and/or any of its components) to the battery cell 14.

In a nonlimiting example, BMS 26 is configured to determine (i.e., capture, measure, read, etc.) data including battery cell data and/or battery cell parameters, e.g., via processing circuitry 100 and/or connector interface 110 and/or lead 50 of lead assembly 24 and/or post 18 and/or bushing 22 and/or lead guide 68, and/or BMS connector 58, and/or openings 70 and/or battery cells 14. In one example, BMS 26 may be configured to determine a parameter of a battery cell 14 and/or battery 10 by using a connection that is established between BMS 26 and the battery cell 14 via bushing 22, post 18 and battery cells 14. Also, BMS 26 may be configured to determine a location of the BMS connector 56 within opening 70 by using a connection that is established between BMS connector 56 and/or opening 70, and/or lead guide 68, and/or sensor 96, and/or member 90, and/or lever 80 via BMS 26 and/or the battery cell 14 via bushing 22, post 18 and battery cells 14. For example, a first opening 70 may be electrically coupled to a first pin of processor 102 of BMS 26, and a second opening 70 may be electrically coupled to a first pin of processor 102 of BMS 26. An electrical parameter associated with the electrical coupling of any of the first and second openings 70 and their corresponding pin may change when BMS connector 56 makes contact with any portion of opening 70 and/or sensor 96. BMS 26 may be configured to measure the location parameter and detect the change to determine that BMS connector 56 has been inserted at certain opening 70 (e.g., based in part on the pin where the change is detected) and any movement of the BMS connector 56 within opening 70.

Further, BMS 26 may be configured to determine a voltage of a battery cell 14 and/or battery 10 by using an electrical connection that is established between BMS 26 and the battery cell 14 via leads 50, lead guide 68, bushing 22, post 18 and battery cells 14. Further, BMS 26 may be further configured to analyze the data. BMS 26 may also be configured to communicate the analyzed data or any other data, e.g., transmit/receive data which may include battery cell data and/or battery cell parameters, e.g., via wiring harness 32 and/or vehicle connector 34 and/or connector interface 110. The analyzed data or any other data may be transmitted to and/or received from another device, e.g., that may be connected to BMS 26 such as via vehicle connector 34 and/or connector interface 110. Communicating data may be performed using a protocol such as CAN and/or LIN via vehicle connector 34 to a vehicle and/or Bluetooth via connector interface 110 to a customer. That is, communicating data is not limited to wired connections/protocols and may also include the use of any wireless connections/protocols to communicate to one or more devices/systems. The arrangement described above is beneficial at least because battery 10 is capable of capture data such as battery cell data (e.g., lead acid battery cell data) and/or process the data and/or communicate the data for monitoring and/failure prediction of battery cells and other battery components.

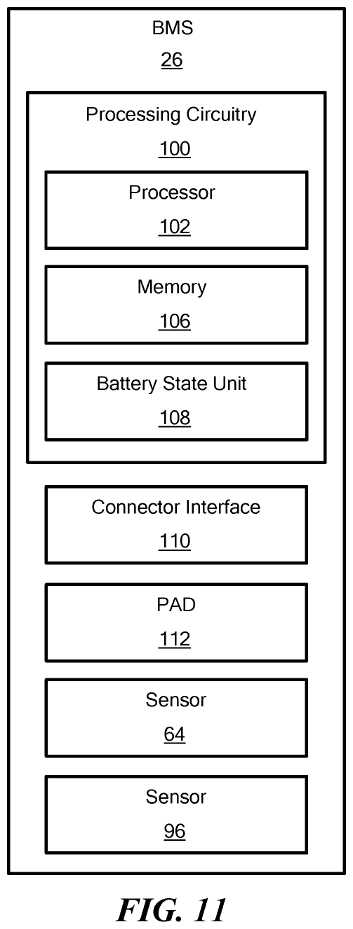

FIG. 12 shows example steps for coupling a pad 112 to one or more components of the battery 10 in accordance with the principles of the present disclose. A weld 58 (e.g., a weld electrically coupling a post 18 and bushing 22 to a lead 50) may be arranged to receive, make contact with, and/or couple to a pad 112. In some embodiments. pad 112 may be made of a thermally conductive material to provide a thermal conductive path from the weld 58 to a sensor 64. However, pad 112 is not limited as such and may be any kind of pad, which may facilitate measurement of any parameter such as a battery cell parameter. Sensor 64 may be any kind of sensor configured to measure a parameter such as a battery cell parameter. For example, sensor 64 may be a temperature sensor, a thermistor, etc. and may allow for measurement of battery cell temperature. Pad 112 may be electrically insulating with respect to the weld 58 and electrical insulator to cast-on strap (COS). That is, pad 112 may be arranged to conduct thermal energy and/or provide electrical insulation. When assembled, pad 112 may contact sensor 64 (e.g., thermistor) on circuit board 62 of BMS 26. In some embodiments, sensor 64 may be mounted to or incorporated within pad 112 (such as in a cavity of the pad that defines an internal space for receiving sensor 64). Sensor 64 may be electrically connected to a corresponding pad (e.g., configured in similar fashion as pad 112) on BMS circuit board 62. In some embodiments, pad 112 has a top surface and a bottom surface. In some other embodiments, the bottom surface of the pad 112 is placed over weld 58 and ring 52 of lead 50. Further, pad 60 may be coupled to weld 58, where at least a portion of the bottom surface of pad 60 only contacts weld 58, where the contact is a direct contact.

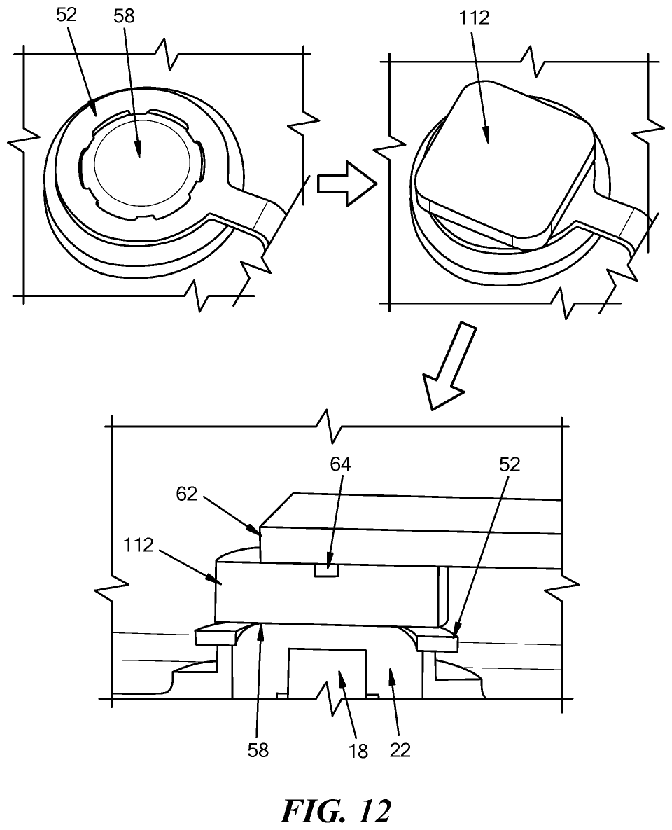

FIG. 13 shows a view of an example pad 112 of a temperature measurement system 11 incorporated in a battery 10, where the pad 112 is coupled to one or more components of the battery 10 according to the principles of the present disclosure and with BMS 26 installed. Pad 112 is shown in contact with sensor 64 (e.g., thermistor) and is coupled to bushing 22. The sensor 64 is located on circuit board 62 such that, when BMS 26 is installed during battery assembly, the sensor 64 aligns with and comes into contact with pad 112. Bushing 22 is coupled to lead ring 52 (e.g., copper ring) of lead 50 and coupled to post 18. Sensor 64 may be affixed and/or electrically coupled to board 62 (and/or any of its elements) of BMS 26. In some embodiments, sensor 64 may be arranged to respond to temperature changes such as by varying a parameter of the sensor 64, e.g., a variation of temperature triggers a variation of resistance. Further, sensor 64 may be electrically coupled to one or more circuit elements of board 62 of BMS 26. Pad 112 may be arranged to provide electrical insulation to one or more elements such as board 62 by allowing thermal energy to pass from post 18 to sensor 64, but not electricity. In some embodiments, system 11 refers to battery 10 and its components.

In one nonlimiting example, electrically conducive post 18 and/or bushing 22 may be made of thermally conductive materials and/or coupled to a corresponding battery cell 14. Although this disclosure refers to bushings 22 as the element upon which pad 112 is positioned, it is understood that particular implementations may not use a bushing 22. Other arrangements for providing thermal conduction from a battery cell 14 to pad 112 through the same electrically conductive element, e.g., post 18, etc., used measure battery cell 14 voltage, can be used.

In some embodiments, when the temperature of a battery cell 14 increases, thermal energy corresponding to the increase in temperature is conducted via post 18, bushing 22, pad 60, and/or sensor 64. Sensor 64 responds to the temperature increase (and/or the thermal energy conducted) by increasing its resistance. BMS 26 and/or board 62 and/or elements of BMS 26 may determine temperature of battery components such as battery cell 14, e.g., based on the resistance value (an/or variation of resistance) of the sensor 64. Thus, BMS 26 may be configured to determine one or more parameters of the battery cells 14 such as temperature (e.g., via pad 60) and voltage (via lead ring 52 of lead 50). In some embodiments, a single system 11 may be included in battery 10, i.e., a single point of temperature measurement which assumes a relatively equal temperature distribution among the battery cells 14. In other embodiments, circuit board 62 can include multiple sensors 64 to allow multiple points of contact with multiple pads 112 for multiple battery cells 14. In still other embodiments, sensors can be embedded in the pad 112 and separately electrically connected to BMS circuit board 62, thereby allowing individual battery cell 14 temperature measurements.

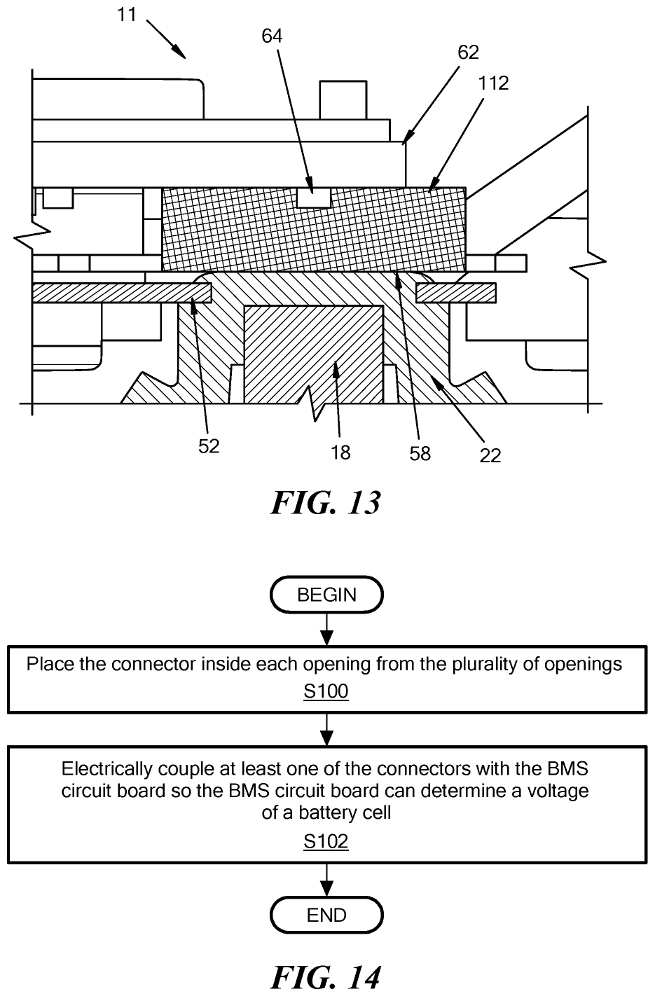

FIG. 14 shows an example method for aligning a connector 56 within a lead guide 68 in a system for determining voltage of a battery cell 14. The system comprises a post 18 indirectly couplable to the battery cell 14, at least one connector 56, a battery management system (BMS) 26 with processing circuitry 100. The BMS 26 includes a circuit board 62, a lead guide 68 with a plurality of openings 70. Each opening 70 has a first portion 76 with a first end 72 and a second portion 78 with a second end 74. The first end 72 has a first diameter. The diameter of the first portion 76 has a tapered diameter from the first end 72 of the first portion 76 to the second portion 78. The second portion 78 has a second diameter that is smaller than the diameter of the first end 72 and the tapered diameter from the first end 72 of the first portion 76 to the second portion 78. The processing circuitry 100 is in communication with the lead guide 68 and configured to measure a location associated with the connector 56 based upon the location associated with the connector 56 in the lead guide 68. The method comprises placing (step S100) the connector 56 inside each opening 70 from the plurality of openings 70. The method further comprises electrically coupling (step S102) at least one of the connectors 56 with the BMS circuit board 62 so the BMS circuit board 62 can determine a voltage of battery cell 14.

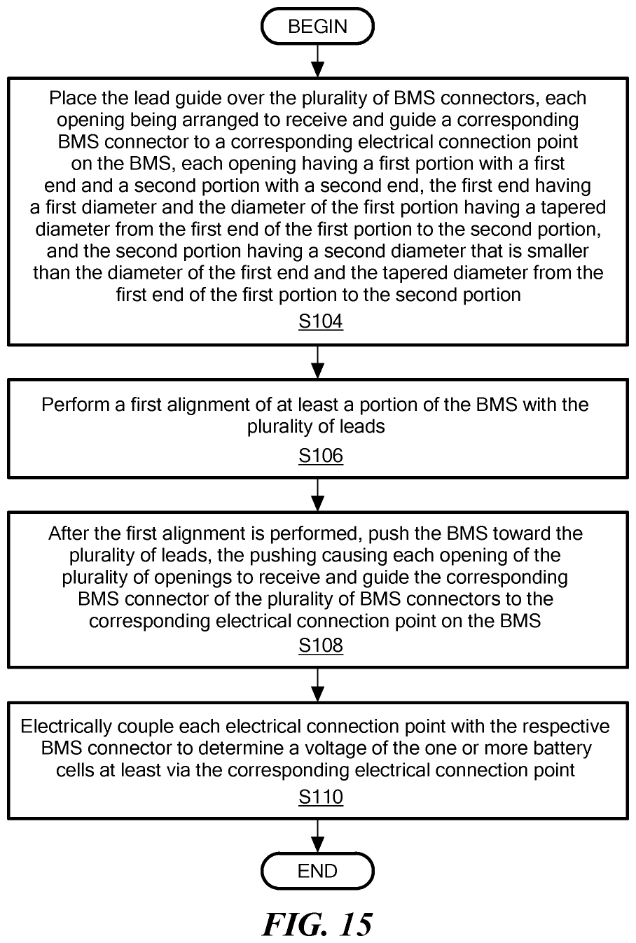

FIG. 15 shows a flowchart of another exemplary method for coupling a plurality of BMS connectors 56 to a lead guide 68 in a battery 10. The battery 10 includes a plurality of posts 18 and a plurality of leads 50. Each post 18 is couplable to one battery cell 14), and each lead 50 has a first end and a second end opposite to the first end. The first end is the BMS connector 56), and the second end is coupled to one post 18. The battery 10 includes a BMS 26. The BMS 26 includes the lead guide 68 and a plurality of connection points 71. The lead guide 68 has a plurality of openings 70. The method includes placing (S104) the lead guide 68 over the plurality of BMS connectors 56. Each opening 70 is arranged to receive and guide a corresponding BMS connector 56 to a corresponding electrical connection point 71 on the BMS 26. Each opening 70 has a first portion 76 with a first end 72 and a second portion 78 with a second end 74. The first end 72 has a first diameter and the diameter of the first portion 76 has a tapered diameter from the first end 72 of the first portion 76 to the second portion 78. The second portion 78 has a second diameter that is smaller than the diameter of the first end 72 and the tapered diameter from the first end 72 of the first portion 76 to the second portion 78. The method also includes performing (S106) a first alignment of at least a portion of the BMS 26 with the plurality of leads 50. In addition, the method also includes after the first alignment is performed, pushing (S108) the BMS 26 toward the plurality of leads 50. The pushing causes each opening 70 of the plurality of openings 70 to receive and guide the corresponding BMS connector 56 of the plurality of BMS connectors 56 to the corresponding electrical connection point 71 on the BMS 26. Further, the method includes electrically coupling (S110) each electrical connection point 71 with the respective BMS connector 56 to determine a voltage of the one or more battery cells 14 at least via the corresponding electrical connection point 71.

In some embodiments, the BMS 26 further comprises a processing circuitry 100), each electrical connection point 71 includes a conductor layer 75 electrically coupled to processing circuitry 100. The method further includes electrically coupling the conductor layer 75 to the respective BMS connector 56.

In some other embodiments, the method further includes performing a second alignment of the respective BMS connector 56 with the conductor layer 75.

In some embodiments, the BMS 26 further includes a processing circuitry 100. The lead guide 68 includes a portion corresponding to at least one opening 70 that is electrically coupled to the processing circuitry 100. The method further includes electrically coupling the respective BMS connector 56 to the processing circuitry 100 via the portion corresponding to the at least one opening 70.

In some other embodiments, the BMS 26 further includes a processing circuitry 100 and a connector 73 coupled to the processing circuitry 100. The method further includes electrically coupling the respective BMS connector 56 to the processing circuitry 100 via the connector 73.

In some embodiments, the connector 73 is individually connected to each connection point 71 of the plurality of connection points 71.

In some other embodiments, each opening 70 from the plurality of openings 70 further includes at least one guide 88), and the method further includes inserting one BMS connector 56 into one opening 70 proximate the at least one guide 88.

It will be appreciated by persons skilled in the art that the present embodiments may be not limited to what may have been particularly shown and described. In addition, unless mention was made above to the contrary, it should be noted that all of the accompanying drawings may be not to scale. A variety of modifications and variations may be possible in light of the above teachings and the following claims.

1. A system for determining a battery cell parameter of one or more battery cells of a battery, the battery comprising a plurality of posts and a plurality of leads, each post being couplable to one battery cell, each lead having a first end and a second end opposite to the first end, the first end being a battery management system, BMS, connector, the second end being coupled to one post, the system comprising:
a BMS comprising:
a plurality of electrical connection points;
a lead guide with a plurality of openings, each opening being arranged to receive and guide a corresponding BMS connector to a corresponding electrical connection point on the BMS, each opening having a first portion with a first end and a second portion with a second end, the first end having a first diameter and a diameter of the first portion having a tapered diameter from the first end of the first portion to the second portion, and the second portion having a second diameter that is smaller than the diameter of the first end and the tapered diameter from the first end of the first portion to the second portion; and
processing circuitry electrically coupled to one or more electrical connection points of the plurality of electrical connection points and configured to determine the battery cell parameter of the one or more battery cells at least via the corresponding electrical connection point.

2. The system of claim 1, wherein the lead guide further comprises at least one guide formed as part of a corresponding opening.

3. The system of claim 1, wherein each opening from the plurality of openings has a round shape.

4. The system of claim 1, wherein the lead guide has two guides.

5. The system of claim 2, wherein the each guide is disposed on the first end of the first portion.

6. The system of claim 1, wherein the second end of the second portion has a third diameter, the third diameter being the same as the second diameter.

7. The system of claim 1, wherein the battery further includes a bushing couplable to the battery cell and coupled to the post.

8. The system of claim 7, wherein at least one electrical connection point is couplable to the bushing and the BMS, the BMS being configured to determine a voltage of the battery cell using the at least one electrical connection point.

9. The system of claim 1, wherein at least the first diameter of the first end of the first portion of the opening is adjustable.

10. The system of claim 1, wherein the BMS further includes a circuit board, the lead guide is positioned in a predetermined region on the circuit board such that the BMS connector can be aligned with at least one opening from the plurality of openings of the lead guide.

11. The system of claim 1, wherein one or more electrical connection points is aligned with a corresponding opening.

12. The system of claim 1, wherein one or more electrical connection points comprise a conductor layer electrically coupled to the processing circuitry and arranged to receive and electrically couple to the BMS connector.

13. The system of claim 1, wherein the lead guide comprises a portion corresponding to at least one opening that is electrically coupled to the processing circuitry and arranged to electrically couple to the BMS connector to the processing circuitry.

14. A method for coupling a plurality of battery management system, BMS, connectors to a lead guide in a battery, the battery comprising a plurality of posts and a plurality of leads, each post being couplable to one battery cell, each lead having a first end and a second end opposite to the first end, the first end being the BMS connector, the second end being coupled to one post, the battery comprising a BMS, the BMS comprising the lead guide and a plurality of connection points, the lead guide having a plurality of openings, the method comprising:
placing the lead guide over the plurality of BMS connectors, each opening being arranged to receive and guide a corresponding BMS connector to a corresponding electrical connection point on the BMS, each opening having a first portion with a first end and a second portion with a second end, the first end having a first diameter and the diameter of the first portion having a tapered diameter from the first end of the first portion to the second portion, and the second portion having a second diameter that is smaller than the diameter of the first end and the tapered diameter from the first end of the first portion to the second portion;
performing a first alignment of at least a portion of the BMS with the plurality of leads;
after the first alignment is performed, pushing the BMS toward the plurality of leads, the pushing causing each opening of the plurality of openings to receive and guide the corresponding BMS connector of the plurality of BMS connectors to the corresponding electrical connection point on the BMS; and
electrically coupling each electrical connection point with the respective BMS connector to determine a voltage of the one or more battery cells at least via the corresponding electrical connection point.

15. The method of claim 14, wherein the BMS further comprises a processing circuitry, each electrical connection point includes a conductor layer electrically coupled to processing circuitry, and the method further includes:
electrically coupling the conductor layer to the respective BMS connector.

16. The method of claim 15, wherein the method further includes:
performing a second alignment of the respective BMS connector with the conductor layer.

17. The method of claim 14, wherein the BMS further comprises a processing circuitry, the lead guide comprises a portion corresponding to at least one opening that is electrically coupled to the processing circuitry, and the method further includes:
electrically coupling the respective BMS connector to the processing circuitry via the portion corresponding to the at least one opening.

18. The method of claim 14, wherein the BMS further comprises a processing circuitry and a connector coupled to the processing circuitry, and the method further includes:
electrically coupling the respective BMS connector to the processing circuitry via the connector.

19. The method of claim 18, wherein the connector is individually connected to each connection point of the plurality of connection points.

20. The method of claim 14, wherein each opening from the plurality of openings further comprises at least one guide, the method further includes:
inserting one BMS connector into one opening proximate the at least one guide.
